(19) United States
(12) Patent Application Publication
(10) Pub. No.: US 2023/0306802 A1
(43) Pub. Date: Sep. 28, 2023

(54) DIAGNOSTIC SYSTEM AND METHOD

(71) Applicant: JAGUAR LAND ROVER LIMITED, Warwickshire (GB)

(72) Inventors: Kishore KARANALA, Warwickshire (GB); Tarun CHINTAPALLI, Warwickshire (GB); Sundar SRI, Warwickshire (GB); Abhijith BALAN, Warwickshire (GB); Nikhil SONKUL, Warwickshire (GB); Sarvesh KHANDELWAL, Warwickshire (GB); Bhavya DHURIA, Warwickshire (GB); Shashwat SINHA, Warwickshire (GB)

(21) Appl. No.: 18/191,408

(22) Filed: Mar. 28, 2023

(30) Foreign Application Priority Data
Mar. 28, 2022 (GB) 2204368.1

(51) Int. Cl. G07C 5/08; G07C 5/00; G06N 20/00

(52) U.S. Cl. CPC G07C 5/0833; G07C 5/008; G07C 5/0808; G06N 20/00

(57) ABSTRACT

A method of training a diagnostic model for identifying a fault condition in a vehicle system includes receiving a plurality of vehicle fault condition data sets, each being associated with a known fault condition of a vehicle system. The vehicle fault condition data sets each include audio data representing an audio signal generated by a microphone during operation of the vehicle system having the known fault condition; and operating data indicating an operating state of the vehicle system. Each vehicle fault condition data set is processed. A frequency domain representation of the audio signal is generated and analysed to identify at least one fault indicator component corresponding to the known fault condition. The diagnostic model is trained to identify the at least one fault condition in dependence on the identification of the at least one fault indicator component in each vehicle fault condition data set.

### CROSS REFERENCE TO RELATED APPLICATION

This application claims priority to United Kingdom Patent Application No. GB2204368.1, which was filed on 28 Mar. 2022.

### TECHNICAL FIELD

The present disclosure relates to a diagnostic system and method. The present disclosure relates to a computer-implemented method of training a diagnostic model. The diagnostic model may be configured to identify a fault condition in a vehicle system. Aspects of the invention relate to a non-transitory computer-readable medium, a diagnostic model, a vehicle monitoring system and a vehicle.

### BACKGROUND

It is known that audio can be used for the analysis and diagnosis of systems in a vehicle, such as an automobile. However, vehicles are complex systems with numerous interconnected systems. As a result, the analysis of the audio signal can be challenging since it is difficult to differentiate between different audio components.

It is an aim of the present invention to address one or more of the disadvantages associated with the prior art.

### SUMMARY OF THE INVENTION

Aspects and embodiments of the invention provide a computer-implemented method of training a diagnostic model, a non-transitory computer-readable medium, a diagnostic model, a vehicle monitoring system and a vehicle as claimed in the appended claims.

According to an aspect of the present invention there is provided a computer-implemented method of training a diagnostic model to identify a fault condition; the method comprising receiving a plurality of vehicle fault condition data sets, each vehicle fault condition data set being associated with a known fault condition of a vehicle system, wherein the vehicle fault condition data sets each comprise:
audio data representing an audio signal generated by a microphone during operation of the vehicle system having the known fault condition; and
operating data indicating an operating state of the vehicle system;
the method comprising:
   processing each vehicle fault condition data set, the processing comprising:
   generating a frequency domain representation of the audio signal;
   analysing the frequency domain representation of the audio signal to identify at least one fault indicator component corresponding to the known fault condition; and
   training the diagnostic model to identify the at least one fault condition in dependence on the identification of the at least one fault indicator component in each vehicle fault condition data set.

The operating state of the vehicle system may indicate that the vehicle system is active or inactive. Alternatively, or in addition, the operating state of the vehicle system may indicate an operating speed or a rotational speed of the vehicle system.

The vehicle fault condition data sets may comprise operating data for other vehicle systems. The vehicle fault condition data sets may each comprise operating data relating to one or more of the following: engine speed, vehicle speed, brake pressure, etc. The processing of the vehicle fault condition data sets may be performed in respect of two or more different types of the operating data.

The vehicle system may comprise an internal combustion engine. The operating state of the vehicle system may indicate an operating speed (rpm) of the internal combustion engine.

The vehicle system may comprise an electric traction motor. The operating state of the vehicle system may indicate an operating speed (rpm) of the electric traction motor.

The vehicle system may comprise a (friction) brake for retarding motion of the vehicle. The operating state of the vehicle system may indicate a brake pressure.

The vehicle system may comprise a balancer shaft. The operating state of the vehicle system may indicate a rotational speed (rpm) of the balancer shaft.

The vehicle system may comprise a turbocharger. The operating state of the vehicle system may indicate a rotational speed (rpm) of the turbocharger.

The or each vehicle fault condition data set may comprise a fault condition identifier for identifying the known fault condition.

The operating data and the audio data may be synchronised with each other. A time stamp may be applied to the operating data and the audio data. The time stamp may be referenced to facilitate synchronisation of the operating data and the audio data.

The frequency domain representation of the audio signal may be correlated with the operating data for the one or more vehicle systems. For example, the frequency domain representation may be correlated with the operating data generated for a time period when the fault was present (i.e., the fault was occurring) during operation of the vehicle.

The operating data may be used to identify a region (or part) of the audio signal where a particular fault condition is expected to manifest as an identifiable audio component. The presence or absence of a fault identification component in the identified region of the audio signal may be used to determine a corresponding presence or absence of the associated fault condition. It will be understood that this analysis may be performed in the frequency domain representation of the audio signal.

The processing of the vehicle fault condition data set may comprise applying a transform to the audio data to generate the frequency domain representation of the audio signal. The transform may comprise a Fast Fourier Transform (FFT). The transform may comprise a spectrogram.

The analysis of the frequency domain representation of the audio signal may be performed in combination with the operating data indicating an operating state of the vehicle system.

The identification of the at least one fault indicator component of the frequency domain representation may comprise decomposing the frequency domain representation of the audio signal in dependence on the operating state of the vehicle system.

The frequency domain representation of the audio signal may be decomposed by normalising the frequency domain representation with respect to the operating state of the vehicle system.

According to a further aspect of the present invention there is provided a non-transitory computer-readable medium having a set of instructions stored therein. When executed by a processor, the instructions may cause the processor to implement the computer-implemented method claimed in any one of the preceding claims.

According to a further aspect of the present invention there is provided a diagnostic model for identifying a fault condition in a vehicle. The diagnostic model may be trained in accordance with the computer-implemented method described herein.

According to a further aspect of the present invention there is provided a computational device having at least one electronic processor configured to implement the diagnostic model described herein.

According to a further aspect of the present invention there is provided a vehicle monitoring system for identifying a fault condition in a vehicle system of a vehicle; the vehicle monitoring system comprising a controller configured to:
aggregate audio data representing an audio signal generated by a microphone during operation of the vehicle system;
aggregate operating data indicating an operating state of the vehicle system;
use a diagnostic model to analyse the audio data and the operating data to identify one or more fault conditions; and
output the one or more identified fault condition.

The fault identification report may comprise one or more fault condition identified by the diagnostic model. The fault identification report may classify or otherwise grade a severity of the identified vehicle fault condition. The fault identification report may include a maintenance or servicing recommendation to correct the identified fault.

The fault identification report may be displayed in the vehicle. Alternatively, or in addition, the fault identification report may be output for display on a cellular telephone which may be associated with a user of the vehicle.

The controller may comprise at least one electronic processor, the at least one electronic processor comprising:
at least one electrical input for receiving the audio signal from the microphone and for receiving the operating data from a vehicle communication system; and
at least one electrical output for outputting the audio data and the operating data.

The operating data may be used to identify a region (or part) of the audio signal where a particular fault condition is expected to manifest as an identifiable audio component. The controller may be configured to identify the presence or absence of a fault identification component in the identified region of the audio signal. The presence of the fault identification component may be used to identify the presence of the associated fault condition. The absence of the fault identification component may be used to identify the absence of the associated fault condition. It will be understood that this analysis may be performed in the frequency domain representation of the audio signal.

The diagnostic model may be implemented onboard, for example by one or more controller provided on the vehicle. Alternatively, the diagnostic model may be implemented offboard, for example by a remote server. The audio data and the operating data may be output to a remote server for processing by the diagnostic model.

A fault identification report may be generated by the diagnostic model indicating the one or more identified fault condition. It will be understood that the fault identification report may indicate that no fault conditions were identified by the diagnostic model. The fault identification report may be output, for example to a display screen. In embodiments in which the diagnostic model is implemented offboard, the fault identification report may be sent from the remote server to the vehicle system.

The diagnostic model described herein has particular application in diagnosing a mechanical fault (as opposed to an electrical fault or a software fault which is less likely to result in generation of a corresponding audio component).

According to a further aspect of the present invention there is provided a vehicle comprising a vehicle monitoring system as described herein. The vehicle may comprise a microphone for capturing the audio signal.

Any control unit or controller described herein may suitably comprise a computational device having one or more electronic processors. The system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller or control unit, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. The control unit or controller may be implemented in software run on one or more processors. One or more other control unit or controller may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle configured to capture an audio signal for analysis by an audio processing system in accordance with an embodiment of the present invention;

FIG. 2 shows a schematic representation of the operation of the audio processing system shown in FIG. 1;

FIG. 3 shows a schematic representation of the operation of the diagnostic model used in the audio processing system shown in FIG. 2;

FIG. 4 shows a schematic representation of the audio processing system for monitoring the vehicle shown in FIG. 1;

FIG. 5 shows a schematic representation of an onboard controller in the audio processing system shown in FIG. 4;

FIG. 6 shows a schematic representation of an offboard controller in the audio processing system shown in FIG. 2;

FIG. 7A shows a first audio spectrogram of an audio signal of an unbalanced balancer shaft;

FIG. 7B shows a second audio spectrogram of an audio signal of brake squeal from a friction brake;

FIG. 7C shows a third audio spectrogram of an audio signal of turbo whine from a turbocharger; and

FIG. 8 shows a block diagram representing a method of training a diagnostic model for identifying a fault condition in a vehicle system.

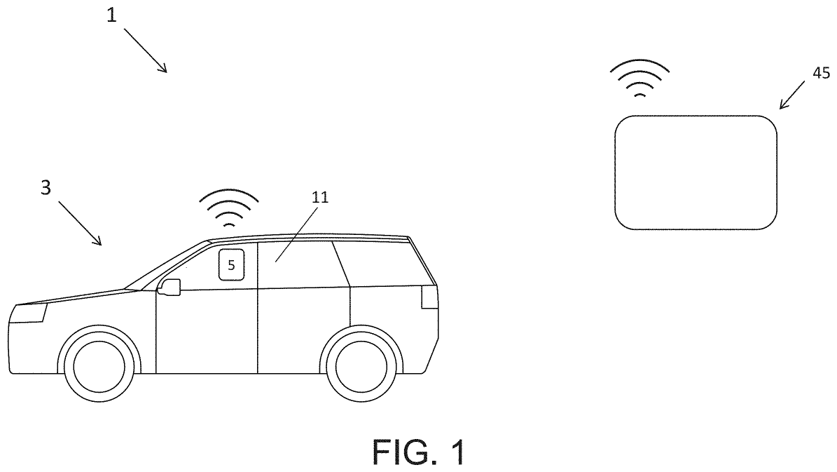

### DETAILED DESCRIPTION

An audio processing system 1 in accordance with an embodiment of the present invention is described herein with reference to the accompanying figures. The audio processing system 1 in the present embodiment is suitable for processing an at least one audio signal AS-n captured by a microphone 5 provided on a vehicle 3. The audio processing system 1 is described herein with reference to the analysis of a first said audio signal AS-1. The audio processing system 1 is implemented in a vehicle monitoring system VMS to identify one or more fault conditions in the vehicle 3.

The vehicle 3 in the present embodiment is a road vehicle, such an automobile, a sports utility vehicle or a utility vehicle. The vehicle 3 comprises a plurality of vehicle systems VS-n. The audio processing system 1 in accordance with the present embodiment is configured to identify or predict a fault condition in one or more of the vehicle systems VS-n operating on the vehicle 3. In use, one or more of the vehicle systems VS-n functions as an audio source that emits sound in the form of acoustic waves. The vehicle system(s) VS-n that emit sound waves are referred to herein as sound-emitting vehicle systems VS-n. The sound waves may have frequencies in the audible frequency range (less than approximately 20,000 hertz) and optionally also the ultrasonic frequency range (greater than approximately 20,000 hertz). In use, the microphone 5 captures at least some of the sound waves generated by the sound-emitting vehicle systems VS-n and generates the first audio signal AS-1. The resulting first audio signal AS-1 comprises audio data representing the sound waves emitted by the one or more said sound-emitting vehicle systems VS-n operating on the vehicle 3 at any given time. The microphone 5 in the present embodiment captures the audible sound emitted by the sound-emitting vehicle systems VS-n. In a variant, the microphone 5 could be configured also to capture ultrasonic sound waves for analysis. The audio from the microphone 5 is recorded at a sampling rate of 48000 Hz in the present embodiment. Other sampling rates can be used for sampling the audio. As described herein, the audio processing system 1 is configured to analyse the first audio signal AS-1 to monitor operation of the sound-emitting vehicle systems VS-n. At least in certain embodiments, the audio processing system 1 is configured to identify or to predict a fault condition in one or more of the sound-emitting vehicle systems VS-n.

The sound waves emitted by the sound-emitting vehicle systems VS-n typically have an identifiable audio profile (or audio signature). The analysis of a plurality of the first audio signals AS-1, for example by a machine learning algorithm, enables the identification of the or each audio profile. The presence of the or each audio profile is identifiable within the first audio signal AS-1. The absence of the or each audio profile is also identifiable in the first audio signal AS-1. The audio processing system 1 in accordance with the present embodiment is configured to identify the presence or absence of each audio profile. The or each audio profile may vary dynamically in dependence on the current (i.e., instantaneous) operating state of the associated sound-emitting vehicle system VS-n. For example, the frequency and/or the magnitude of a portion of an audio profile may change in dependence on the operating state of the related vehicle system VS-n. The audio processing system 1 is configured to receive an operating signal OS-n indicating an operating state of the or each sound-emitting vehicle system VS-n. The audio processing system 1 analyses the first audio signal AS-1 in dependence on the indicated operating state of the associated sound-emitting vehicle system VS-n.

The audio profile associated with the or each sound-emitting vehicle system VS-n may change as a fault develops. The audio processing system 1 is configured to analyse the or each audio profile in the first audio signal AS-1 to identify a fault condition in the associated vehicle system VS-n. For example, the audio processing system 1 may identify a variation in part or all of the audio profile which may indicate a fault condition in the associated vehicle system VS-n. As described herein, the audio processing system 1 is configured to decouple the first audio signal AS-1 to identify the or each audio profile associated with the or each sound-emitting vehicle system VS-n. The decoupling of the first audio signal AS-1 is performed in dependence on the determined operating state of the or each sound-emitting vehicle system VS-n. This may account for changes in the audio profile which are related to the instantaneous operating state of the sound-emitting vehicle system VS-n rather than a fault condition.

It will be understood that the audio processing system 1 is operable in conjunction with a range of different second sound-emitting vehicle systems VS-n. By way example, the audio processing system 1 according to the present embodiment is described herein with reference to the following:
a first said sound-emitting vehicle system VS-1 is in the form of an internal combustion engine;
a second said sound-emitting vehicle system VS-2 is in the form of a balancer shaft; and
a third said sound-emitting vehicle system VS-3 is in the form of a turbocharger.

The internal combustion engine VS-1 is provided to generate a propulsive force to propel the vehicle 3. Alternatively, or in addition, the internal combustion engine may be provided to charge an onboard traction battery, for example to power a traction battery to propel the vehicle. The balancer shaft VS-2 is an eccentric shaft provided to balance operational loads in the internal combustion engine VS-1. The turbocharger VS-3 is provided to introduce air into the internal combustion engine VS-1 at a pressure greater than atmospheric pressure. Sound waves associated with the operation of each of the first, second and third sound-emitting vehicle systems VS-1, VS-2, VS-3 are detectable in a cabin 11 of the vehicle 3. Other examples of the sound-emitting vehicle system VS-n include an electric traction motor (not shown). For example, the vehicle 3 may be a plug-in hybrid electric vehicle (PHEV) or a battery electric vehicle (BEV) comprising one or more electric traction motor. Other examples of the sound-emitting vehicle system VS-n include a friction brake which, in use, may generate a brake squeal when subject to a fault condition. The processing of the first audio signal AS-1 may be performed in dependence on a reference velocity (VREF) of the vehicle 3, for example to account for road noise and/or wind noise detectable in the cabin.

The microphone 5 is disposed in a fixed location in the vehicle 3 to provide a consistent measurement of the sounds generated by the or each sound-emitting vehicle system VS-n. This may facilitate a comparison of the first audio signal AS-1 captured on different vehicles 3. In the present embodiment, the first audio signal AS-1 is captured when the internal combustion engine VS-1 is operating at a predetermined engine speed or within a predetermined engine range. The internal combustion engine VS-1 may be controlled to operate at the predetermined engine speed or within the predetermined engine range to facilitate acquisition of the first audio signal AS-1. For example, a control signal may be output to the internal combustion engine VS-1 to request a target operating speed for a predetermined time period. Alternatively, or in addition, the first audio signal AS-1 may be captured when it is determined that the internal combustion engine VS-1 is operating at the predetermined engine speed or within the predetermined engine range. The predetermined engine speed or within the predetermined engine range may be used as entry conditions for capturing the first audio signal AS-1.

A machine learning algorithm may process a plurality of audio signals AS-n to identify changes or variations in the audio profile which are indicative of a fault condition. A diagnostic model DM1 may be generated by the machine learning algorithm, for example by processing a plurality of sets of training data comprising audio signals AS-n which are annotated to indicate one or more known (verified) fault conditions. The diagnostic model DM1 may identify at least one fault indicator component of the audio profile(s) associated with the or each sound-emitting vehicle system VS-n which is indicative of a fault associated with that sound-emitting vehicle system VS-n. The sets of training data may comprise concurrent operating data for the one or more sound-emitting vehicle system VS-n. The resulting diagnostic model DM1 may utilise the operating data to help identify the fault condition. It is envisaged that different audio profiles would be determined in different types or models of vehicle. However, different vehicles 3 of the same type or model show sufficient repeatability to enable identification of one or more fault indicator components indicating a fault condition.

In the present embodiment, the microphone 5 is disposed in the cabin 11. The microphone 5 may be a dedicated device for use exclusively with the audio processing system 1. Alternatively, the microphone 5 may be used by one or more other systems, such as an infotainment system. The audio processing system 1 may communicate with a telematic unit on the vehicle 3 to access the audio signal AS-n. By way of example, the microphone 5 may also capture voice commands or audio inputs for a communication system provided on the vehicle 3. It will be understood that the microphone 5 could be provided in other locations of the vehicle 3, for example in an engine bay or an electric traction motor compartment. The audio processing system 1 may receive a plurality of audio signals AS-n, for example from a plurality of the microphones 5 disposed in different locations in the vehicle 3.

The audio processing system 1 could be implemented directly on the vehicle 3. For example, one or more controller may be provided on the vehicle 3 to process the audio signal AS-n. In the present embodiment, the processing of the audio signal AS-n is performed offboard on a remote server. The data is output from the vehicle 3 to the remote server for processing. This arrangement reduces the computational requirements onboard the vehicle 3. The data may be transmitted wirelessly, for example over a wireless communication network; or may be downloaded over a wired connection. The data may be transmitted in real-time or offline (i.e., not in real time). In the present embodiment, the data is aggregated and transmitted as a package for analysis. The configuration of the vehicle 3 to aggregate the data will now be described.

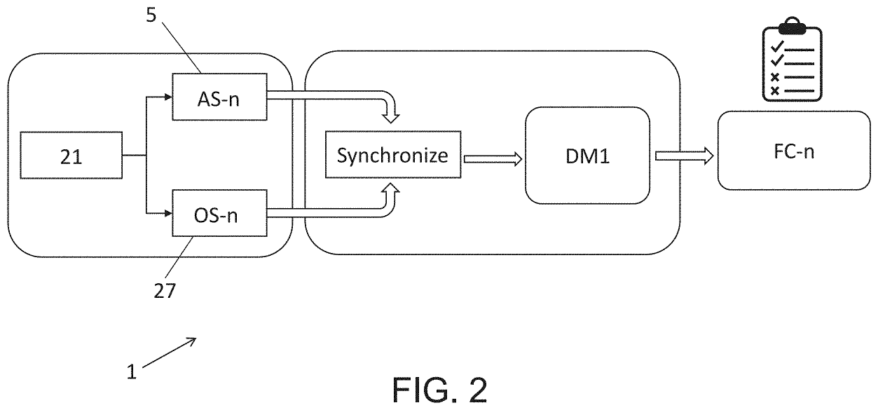

A schematic representation of the operation of the audio processing system 1 is shown in FIG. 2. The microphone 5 is used to capture the audio signal AS-n. The operating state of the one or more vehicle systems VS-n is also captured. For example, one or more vehicle operating signals OS-n may be captured. The audio signals AS-n may comprise one or more of the following: a balancer shaft whine, a (timing) chain rattle, a turbocharger whine, a brake squeal. The audio data and the operating data is synchronized and output to a diagnostic model DM1. The audio data (or a frequency domain representation of the audio signal) may be correlated with the operating data for a time period when the fault was present (i.e., the fault was occurring) during operation of the vehicle.

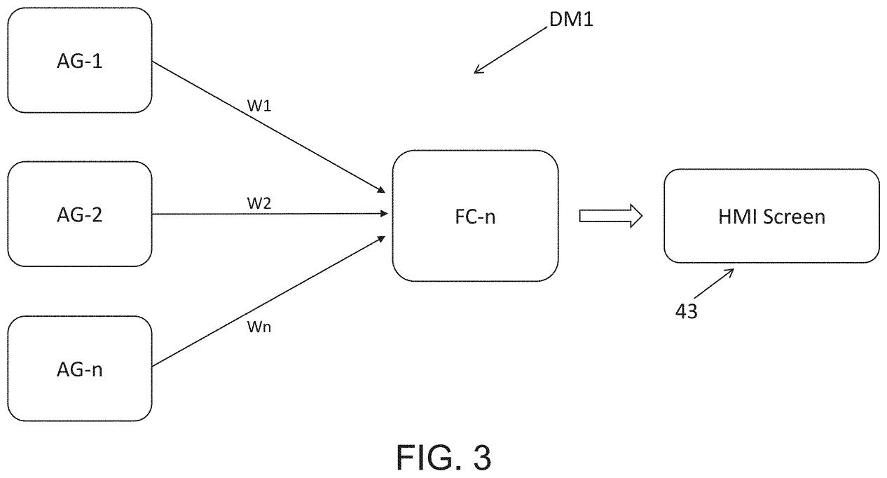

As described herein, the diagnostic model DM1 is configured to output one or more predicted fault condition FC-n. The implementation of the diagnostic model DM1 is represented schematically in FIG. 3. The diagnostic model DM1 implements at least one diagnostic algorithm AG-n. The diagnostic algorithm AG-n may each be configured to identify a particular fault condition. The diagnostic algorithms AG-n may each be tuned to identify fault indicator components associated with a particular fault condition. For example, a first diagnostic algorithm AG-1 may be configured to identify the presence or absence of a balancer shaft whine; a second diagnostic algorithm AG-2 may be configured to identify the presence or absence of a brake squeal; and a third diagnostic algorithm AG-3 may be configured to identify the presence or absence of a turbocharger whine. It will be understood that the diagnostic algorithms AG-n may be configured to identify other fault conditions. The diagnostic algorithms AG-n each generate a fault prediction. The fault predictions may, for example, comprise a weighting Wn indicating a certainty or a probability of the audio component associated with a particular fault condition being present in the audio signal AS-n. The weightings Wn are analysed to make one or more predicted fault conditions FC-n. For example, a comparator may compare the weightings Wn to identify one or more predicted fault conditions FC-n. The one or more predicted fault conditions FC-n may be identified by selecting the one or more weightings Wn determined to have a probability greater than a threshold value. The one or more predicted fault conditions FC-n is output for review, for example on a display screen 43 or in a fault condition report.

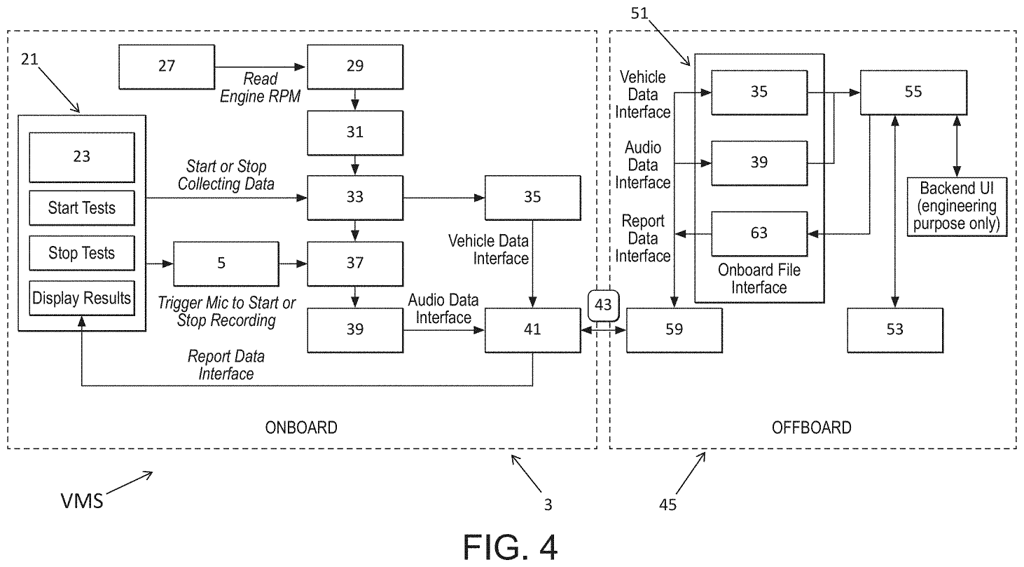

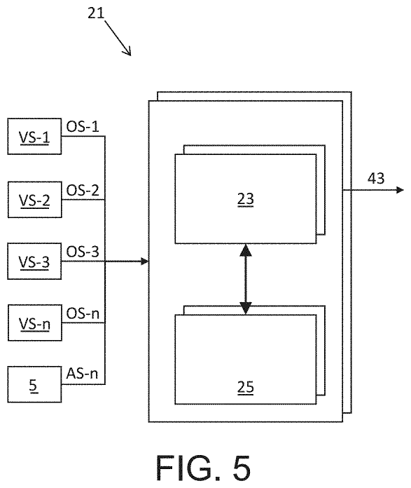

The implementation of the audio processing system 1 will now be described in more detail. As shown in FIGS. 4 and 5, the vehicle 3 comprises an onboard controller 21 comprising at least one first electronic processor 23 and a first system memory 25. The at least one electronic processor 23 has at least one electrical input for receiving vehicle operating signals OS-n and the audio signal AS-n. The onboard controller 21 is configured to read the vehicle operating signals OS-n from a vehicle communication bus 27, such as Controller Area Network (CAN) bus. The vehicle operating signals OS-n may be used to identify those parts of the audio signal AS-n where the fault condition is supposed to exist, as per theoretical analysis. The operating signals OS-n may comprise operating data indicating a current (i.e., instantaneous) operating state of the one or more vehicle systems VS-n. Alternatively, or in addition, the operating signals OS-n may comprise historical data, for example indicating a past operating state of the one or more vehicle systems VS-n. In the present embodiment, a first said operating signal OS-1 may indicate an operating speed of the internal combustion engine VS-1. A second said operating signal OS-2 may indicate a rotational speed of the balance shaft VS-2. A third said operating signal OS-3 may indicate a rotational speed of the turbocharger VS-3. It will be understood that one or more of the first, second and third operating signals OS-1, OS-2, OS-3 may be used by the audio processing system 1. One or more additional operating signal OS-n may be captured, such as a brake pressure and vehicle speed.

As shown in FIG. 4, the onboard controller 21 comprises a data client 29, a data collector 31 and a data aggregator 33. The data client 29 reads the operating signals OS-n and collects the operating data for the vehicle systems VS-n. The operating data is aggregated by the data aggregator 33 and stored in a vehicle operating database 35 provided in the first system memory 25. The onboard controller 21 comprises an audio data recorder 37 for recording the audio data contained in the audio signal AS-n captured by the microphone 5. The audio data is stored in a vehicle audio database 39 provided in the first system memory 25. The operating data and the audio data stored in the vehicle operating database 35 and the vehicle audio database 39 is packaged by an onboard network engine 41. A data package 43 comprising the vehicle operating database 35 and the vehicle audio database 39 is transmitted to a remote server (designated generally by the reference numeral 45). The data package may optionally be output for display on a screen 43 provided in the vehicle 3.

The operating signal OS-n may be analysed to determine when the current operating conditions are expected to manifest (or induce) a particular fault condition. One or more operating conditions may be defined as being associated with the or each fault condition. The onboard controller 21 may be configured selectively to collect the audio data and/or the operating data in dependence on a determination that the current operating conditions correspond to the predefined (fault inducing) operating conditions. The data aggregator 33 may be configured to aggregate the operating data when the predefined operating conditions are identified. This may reduce the amount of audio data and/or operating data aggregated for processing by the audio processing system 1.

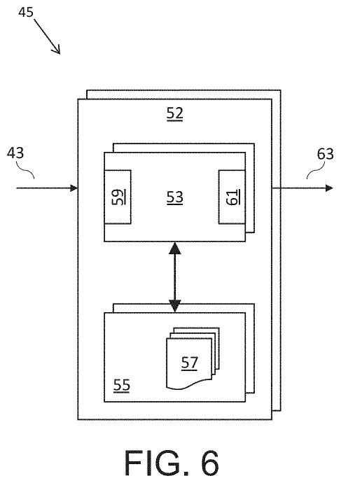

The remote server 45 is configured to receive the data package 43 comprising the vehicle operating database 35 and the vehicle audio database 39. The remote server 45 comprises an offboard controller 51. As shown in FIG. 6, the offboard controller 51 comprises at least one second electronic processor 53 and a system memory 55. A set of instructions 57 is provided for controlling operation of the at least one second electronic processor 53. The instructions 57 may, for example, be stored on the system memory 55. When executed by the at least one second electronic processor 53, the instructions 57 cause the at least one electronic processor 53 to perform the method(s) described herein. The offboard controller 51 comprises at least one input 59 and at least one output 61. The at least one input 59 may, for example, comprise an offboard network engine. The at least one input 57 is configured to receive the data package 43 from the transmitted by the onboard controller 21. The at least one second electronic processor 53 is configured to extract the first audio signal AS-1 and the corresponding operating signal(s) OS-n. The first audio signal AS-1 and the operating signal(s) OS-n is synchronized to enable determination of changes in the or each audio profile associated with contemporaneous changes in the operating state of the associated sound-emitting vehicle system VS-n. Timestamps may be applied to the audio signal AS-n and the operating signal(s) OS-n to facilitate synchronisation. The at least one output 61 is configured to output a report 63, for example fault identification information and/or fault diagnostic information. The report 63 may be output to a display or output as a diagnostics report, for example. Alternatively, or in addition, the report 63 may be transmitted to the vehicle 3 or to a user associated with the vehicle 3. A user may access the report 63 directly on the vehicle 3.

The at least one second electronic processor 53 is configured to process the first audio signal AS-1 in dependence on the indicated operating state of the associated sound-emitting vehicle system VS-n. The processing of the first audio signal AS-1 may be performed in real time or may be performed offline (i.e., not in real time). The first audio signal AS-1 generated by the microphone 5 is in a time domain. The at least one electronic processor 53 is configured to transform the audio signal AS-1 to a frequency domain. The subsequent analysis of the audio signal AS-1 is performed with respect to frequency (rather than time). The frequency domain provides a quantitative indication of the fault indicator components of the audio signal AS-1 at each frequency. The at least one electronic processor 53 applies a transform, such as a Fourier transform, to decompose the audio signal AS-1 into a plurality of frequency components. By way of example, the at least one second electronic processor 53 implements a fast Fourier transform algorithm to determine a discrete Fourier transform of the audio signal AS-1. Other transforms may be used to transform the audio signal AS-1. A transform creates a frequency domain representation of the audio signal AS-1. A spectrogram provides a visual representation of the spectrum of frequencies of the audio signal AS-1 as it varies with respect to time. The frequency domain representation comprises information about the frequency content of the audio signal AS-1. The magnitude of the frequency components provides an indication of a relative strength of the frequency components. The processing of the audio signal AS-1 enables decoupling (i.e., separation or isolation) of the audio profiles associated with the sound-emitting vehicle systems VS-n. This enables analysis of each audio profiles present in the audio signal AS-1.

The audio profile associated with one or more fault conditions in each of the sound-emitting vehicle systems VS-n may be determined through analysis of empirical data. An audio signal AS-n may be captured by the microphone 5 when one or more known fault condition is present. The captured audio signals AS-n may be analysed to determine one or more fault indicator components of the presence of the or each fault condition in the vehicle system(s) VS-n. The audio processing system 1 described herein may analyse the first audio signal AS-1 to identify the or each fault indicator component.

A diagnostic model DM1 may be used to identify a fault condition in the vehicle system VS-n. A standard (or reference) audio profile may be defined for the or each vehicle system VS-n. If the analysis of the audio data indicates that the audio profile differs from the standard audio profile, the diagnostic model DM1 may determine that a fault condition is present in the vehicle system VS-n. One or more active orders may be identified through analysis of the audio profile. The one or more active order may represent an audio component which is in-phase with a vehicle system VS-n. The one or more active order may correspond to a resonant audio frequency or a whole number multiple (the whole number being greater than or equal to one) of a natural frequency. The identified active order(s) may be used as an identifier of a fault condition. A magnitude and/or a location of one or more of the active orders identified in the frequency domain composition may be used to identify a fault condition. By way of example, changes in the magnitude and/or the location of the active orders may indicate a fault condition.

As outlined herein, a machine learning algorithm may be used to train the diagnostic model DM1. The machine learning algorithm may process a plurality of sets of training data to determine a correlation between a component of the audio profile associated with a vehicle system and a fault condition in that vehicle system. The training data sets comprise the aggregated audio data and the aggregated operating data. For the purpose of training the diagnostic model DM1, each training data set is labelled (annotated) to identify a known fault condition manifesting at the time the audio signal is generated. The label may identify one or more time periods when the fault condition is manifesting to aid identification of the fault condition, for example if the fault condition is intermittent or occurs only under certain operating conditions. The operating data indicates the operating status of the vehicle systems VS-n concurrent with the acquisition of the audio signals represented in the audio data. The or each training data set typically indicates a type of the fault condition, for example to identify a whine emanating from the balancer shaft VS-2 or the turbocharger VS-3. The training data sets comprise the aggregated operating data representing the operating state of the vehicle system(s) VS-n. The audio data and the operating data is synchronized to facilitate correlation between the audio data and the operating data. The audio data may represent an audio signal in respect of a first time period during which the fault condition is present; and/or an audio signal in respect of a second time period during which the fault condition is absent. In the present example, the operating data may indicate the operating status of the vehicle systems VS-n in the first time period and/or the second time period.

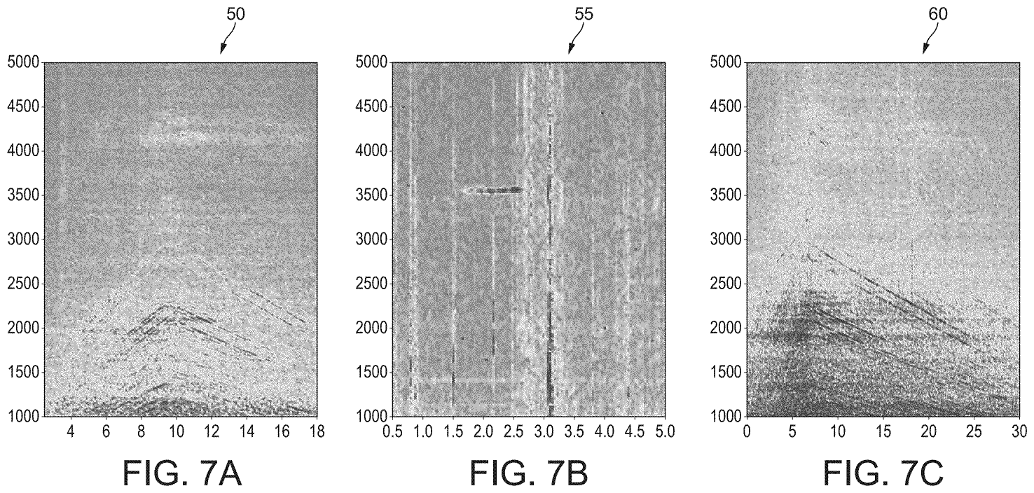

As described herein, a transform is applied to the audio data to generate a frequency domain representation of the audio signal. The transform generates an audio spectrogram representing the audio signal. The transform is typically a Fast Fourier Transform (FFT). A first audio spectrogram 50 representing the audio signal captured for an unbalanced balancer shaft VS-2 is shown in FIG. 7A. A second audio spectrogram 55 representing the audio signal captured for brake squeal from a friction brake is shown in FIG. 7B. A third audio spectrogram 60 representing the audio signal captured for turbo whine from a turbocharger VS-3 is shown in 7C. The method comprises extracting one or more identifiable components from the frequency domain representation. The method may, for example, extract one or more active events in the frequency domain representation. The extracted component is supplied to the machine learning algorithm to train the diagnostic model DM1 to identify the corresponding fault condition (as identified by the labelling associated with the training data set). This training process is repeated using a plurality of the training data sets. The weights in the diagnostic model DM1 may be updated for each iteration to reduce an error function. Weights for the results from each model are calculated based on the previous validation. The diagnostic model DM1 is thereby iteratively updated until sufficiently mature to identify fault conditions. In use, the diagnostic model DM1 analyses an audio signal to identify the presence and absence of fault conditions.

The diagnostic model DM1 may be updated continuously or on an ongoing basis, for example as new training data sets are generated. The new training data sets may be generated when additional fault condition data becomes available. For example, fault condition data may become available when the vehicle is serviced or repaired, for example to remedy a fault condition. A service technician may log or record the fault condition, thereby generating new fault condition data. The aggregated audio data and the operating data may be labelled (annotated) to identify the new fault condition. The resulting data set may be used as a training data set for the diagnostic model DM1.

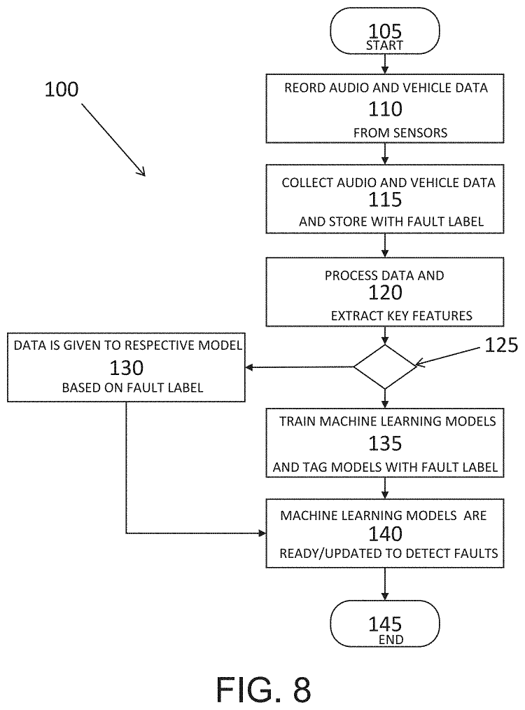

A block diagram 100 representing a method of training a diagnostic model DM1 is shown in FIG. 8. The process is initiated (BLOCK 105). The first audio signal AS-1 and the corresponding operating signal(s) OS-n of the vehicle systems VS-n are captured (BLOCK 110). The audio and vehicle data is collected and stored with a fault label, for example indicating a fault condition (BLOCK 115). The data is processed as described herein to extract key audio components (BLOCK 120). Data outputs for data prediction and data training respectively (BLOCK 125). The labelled data and the extracted audio components are output to a data fault prediction model for fault prediction of a fault condition (BLOCK 130); and to a machine learning model for data training (BLOCK 135). The diagnostic model DM1 comprises one or more fault prediction models. In the present embodiment, the diagnostic model DM1 comprises a plurality of fault prediction models. The data is supplied to respective fault prediction models based on the fault label and a fault prediction is made of the fault condition (BLOCK 130). The machine learning models are trained with the extracted audio components and tagged with a fault label (BLOCK 1350). The machine learning models are ready/updated to detect faults (BLOCK 140). The outcome of the respective fault prediction models (BLOCK 130) is used to update the machine learning models (BLOCK 140). The process is complete (BLOCK 145).

The audio data in the present embodiment is transmitted from the vehicle 3 to the remote server 45 for processing of the audio signal. In a variant, the audio data could be processed onboard on the vehicle 3. The onboard controller 21 in this arrangement would be configured to transform the audio signal to the frequency domain and decouple the audio profiles.

It will be appreciated that various changes and modifications can be made to the present invention without departing from the scope of the present application.

The audio processing system 1 may be configured to output a control signal to modify operation of the one or more of the vehicle systems VS-n. The control signal may be configured to provide a predetermined change in the operation of the vehicle system VS-n, for example a predetermined variation in an operating speed of the vehicle system VS-n. The audio processing system 1 may identify a variation or fluctuation in the first audio signal AS-1 resulting from the modified operation of the one or more of the vehicle systems VS-n. This control strategy may facilitate differentiating between different vehicle systems VS-n or may enable verification that an identified audio profile corresponds to a particular VS-n. This control strategy may be used to differentiate between two or more like or similar vehicle systems VS-n, for example to differentiate between first and second electric traction motors provided on the vehicle 3.

LABELS BLOCK DIAGRAM 100

| | |
|---|---|
| 105 | START |
| 110 | RECORD THE AUDIO AND VEHICLE DATA FROM SENSORS |
| 115 | AUDIO AND VEHICLE DATA IS COLLECTED AND STORED |
| | WITH FAULT LABEL |
| 120 | DATA IS PROCESSED AND KEY FEATURES EXTRACTED |
| 125 | DATA PREDICTION AND DATA TRAINING OUTPUTS |
| 130 | DATA IS GIVEN TO RESPECTIVE MODEL BASED ON FAULT |
| | LABLE TO PREDICT FAULT CONDITION |
| 135 | MACHINE LEARNING MODELS ARE TRAINED WITH THE |
| | EXTRACTED FEATURES AND TAGGED WITH A FAULT LABLE |
| 140 | MACHINE LEARNING MODELS ARE READY/UPDATED TO |
| | DETECT FAULTS |
| 145 | END |

We claim:

1. A computer-implemented method of training a diagnostic model for identifying a fault condition in a vehicle system, the method comprising:
receiving a plurality of vehicle fault condition data sets, each vehicle fault condition data set being associated with a known fault condition of a vehicle system, wherein the vehicle fault condition data sets each comprise:
audio data representing an audio signal generated by a microphone during operation of the vehicle system having the known fault condition, and
operating data indicating an operating state of the vehicle system;
processing each vehicle fault condition data set, the processing comprising:
generating a frequency domain representation of the audio signal,
analysing the frequency domain representation of the audio signal to identify at least one fault indicator component corresponding to the known fault condition, and
training the diagnostic model to identify the at least one fault condition in dependence on the identification of the at least one fault indicator component in each vehicle fault condition data set.

2. The computer-implemented method as claimed in claim 1, wherein each vehicle fault condition data set comprises a fault condition identifier for identifying the known fault condition.

3. The computer-implemented method as claimed in claim 1, wherein the operating data and the audio data are synchronised with each other.

4. The computer-implemented method as claimed in claim 1, wherein the processing of the vehicle fault condition data set comprises applying a transform to the audio data to generate the frequency domain representation of the audio signal.

5. The computer-implemented method as claimed in claim 4, wherein the transform comprises a Fast Fourier Transform.

6. The computer-implemented method as claimed in claim 1, wherein identifying the at least one fault indicator component in the frequency domain representation comprises decomposing the frequency domain representation of the audio signal in dependence on the operating state of the vehicle system.

7. The computer-implemented method as claimed in claim 6, wherein decomposing the frequency domain representation of the audio signal comprising normalising the frequency domain representation with respect to the operating state of the vehicle system.

8. A non-transitory computer-readable medium having a set of instructions stored therein which, when executed, cause a processor to implement the computer-implemented method claimed in claim 1.

9. A diagnostic model for identifying a fault condition in a vehicle, the diagnostic model being trained in accordance with the computer-implemented method claimed in claim 1.

10. A computational device having at least one electronic processor configured to implement the diagnostic model claimed in claim 9.

11. A vehicle monitoring system for identifying a fault condition in a vehicle system of a vehicle; the vehicle monitoring system comprising a controller configured to:
aggregate audio data representing an audio signal generated by a microphone during operation of the vehicle system;
aggregate operating data indicating an operating state of the vehicle system;
use a diagnostic model to analyse the audio data and the operating data to identify one or more fault conditions; and
output the one or more identified fault conditions.

12. A vehicle monitoring system as claimed in claim 11, wherein the controller comprises at least one electronic processor, the at least one electronic processor comprising:
at least one electrical input for receiving the audio signal from the microphone and for receiving the operating data from a vehicle communication system; and
at least one electrical output for outputting the audio data and the operating data.

13. A vehicle monitoring system as claimed in claim 11, wherein the audio data and the operating data are output to a remote server for processing by the diagnostic model; and a fault identification report is received from the remote server indicating the one or more identified fault condition.

14. A vehicle comprising a vehicle monitoring system as claimed in claim 11, the vehicle comprising a microphone for capturing the audio signal.
